(19) United States
(12) Patent Application Publication
(10) Pub. No.: US 2017/0175959 A1
(43) Pub. Date: Jun. 22, 2017

(54) Process for User Interaction With a Flashlight Via A Smart Cradle

(71) Applicant: Mag Instrument, Inc., Ontario, CA (US)

(72) Inventors: Anthony Maglica, Ontario, CA (US); Benny M. Osorio, Ontario, CA (US); Stacey H. West, Ontario, CA (US)

(73) Assignee: Mag Instrument, Inc., Ontario, CA (US)

(21) Appl. No.: 15/446,981

(22) Filed: Mar. 1, 2017

Related U.S. Application Data
(63) Continuation of application No. 15/387,426, filed on Dec. 21, 2016.
Application No. 15/387,426 is a continuation of application No. 14/490,614, filed on Sep. 18, 2014.
(60) Provisional application No. 61/879,586, filed on Sep. 18, 2013.

(51) Int. Cl. F21L 4/08; H02J 7/00; G05B 15/02

(52) U.S. Cl. CPC F21L 4/085; G05B 15/02; H02J 7/0044; H02J 7/0021

(57) ABSTRACT

A user electronically interacts with a flashlight via a computer and application software once the flashlight has been inserted into, and engages, a smart cradle configured with a printed circuit board (“PCB”) that can communicate electronically with both the flashlight and the computer. Application software allows the user to access a mode control circuit for changing operational modes available on the flashlight without having to manipulate a manual control of the flashlight, monitor battery life, access data files relating to the flashlight, and load information into memory of the PCB.

### CROSS-REFERENCE TO RELATED APPLICATION

This application is a continuation application of U.S. Ser. No. 15/387,426, filed Dec. 21, 2016 which itself a continuation application of U.S. Ser. No. 14/490,614, filed Sep. 18, 2014, which is a non-provisional application which claims priority from U.S. Ser. No. 61/879,586, filed Sep. 18, 2013, the contents of all of which are specifically incorporated by reference as if fully set forth herein.

### FIELD OF THE INVENTION

The field of the invention generally relates to cradles that may receive and recharge a lighting device, including charging cradles for rechargeable flashlights.

### BACKGROUND OF THE INVENTION

Rechargeable flashlights and other lighting devices have existed for some time. These types of devices are often sold with some type of recharging device. Recharging devices may have different designs. Certain recharging devices may plug into the lighting device. Other recharging devices may comprise a cradle that receives the lighting device and makes electrical contact with the device to charge it.

Certain existing cradles may contain a number of components that may increase cost and complexity. Such cradles may also be prone to breaking. In addition, existing cradles may be large and cumbersome to utilize in small spaces and to store away properly when not in use. Others may be difficult to take on travel because of their larger size.

Other existing cradles may be difficult to understand how they are to be properly configured with a rechargeable lighting device, and may not be intuitively easy to operate thus leading to an unsatisfactory user experience.

In addition, existing cradles are typically limited in the information they provide. Oftentimes, a cradle will just advise a user that the charge is complete. Cradles typically do not have the ability to monitor various components and aspects of the rechargeable lighting device such as the device's battery life, battery charging time and LED operational status.

Accordingly, there is a need for an improved charging cradle that addresses the foregoing and other issues.

### SUMMARY OF THE INVENTION

The present invention is generally directed to a process by which a user electronically interacts with a flashlight via a computer and application software once the flashlight has been inserted into, and engages, a smart cradle configured with a printed circuit board (“PCB”) that can communicate electronically with both the flashlight and the computer.

Application software can allow the user to access a mode control circuit for changing operational modes available on the flashlight without having to manipulate a manual control of the flashlight, monitor battery life, access data files relating to the flashlight, and load information into memory of the PCB.

### BRIEF DESCRIPTION OF THE DRAWINGS

FIG. 1 is an exploded view of a charging cradle.

FIG. 2 is a perspective view of a charging cradle.

FIG. 3 is a perspective view of a PCB.

FIG. 4 is a view of the top of a charging cradle.

FIG. 5 is a side view of a lighting device engaged with a charging cradle.

FIG. 6 is a view of a charging cradle engaged with a computer.

### DETAILED DESCRIPTION OF THE PREFERRED EMBODIMENTS

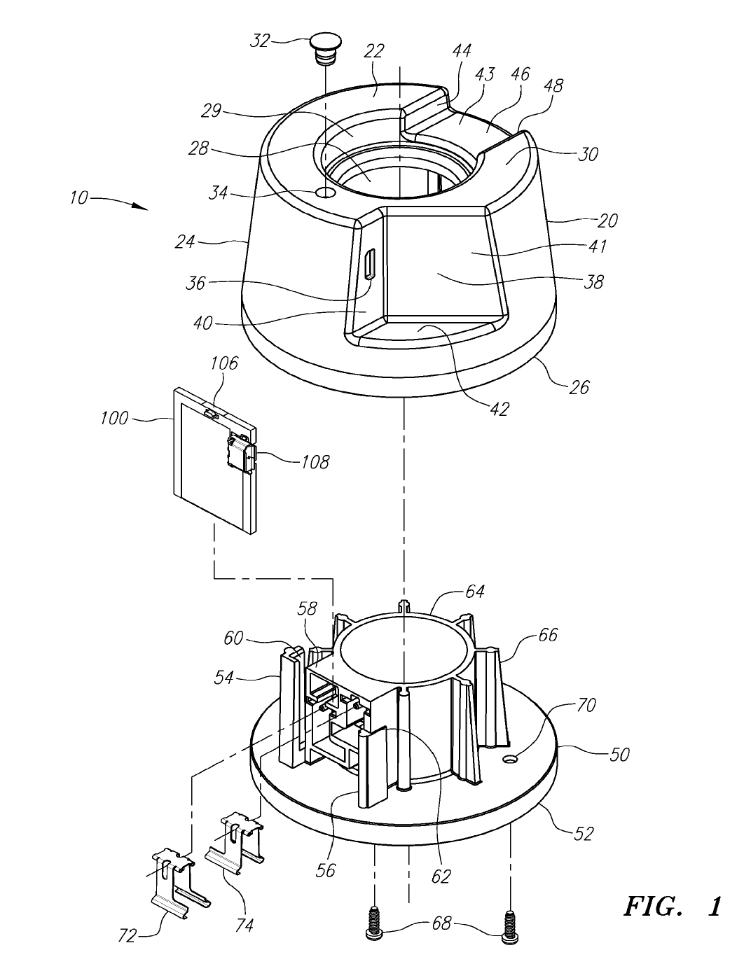

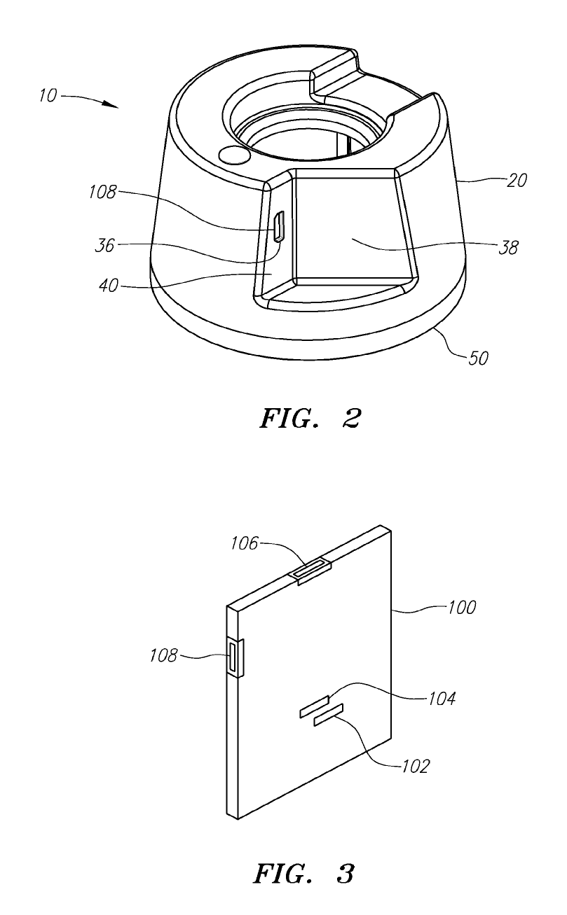

A preferred embodiment of the current invention is now described with reference to FIGS. 1 and 2. FIG. 1 shows components of a charger cradle 10 in an exploded view while FIG. 2 shows the components assembled. Components appearing in more than one figure are identified by the same reference numeral.

Charger cradle 10 may generally be configured to receive a lighting device such as a flashlight in order to recharge its power source. To this end, cradle 10 may include housing 20, base 50 and PCB 100. Housing 20 and base 50 may comprise plastic or other suitable material. Application software for use with cradle 10 and a computer or other controller may also be provided.

The housing 20, base 50 and PCB 100 are now described individually and collectively regarding how they may be generally configured and assembled, and how they may receive a lighting device, such as a rechargeable flashlight, in order to recharge its power source. Later sections will describe how the charger cradle 10 works in conjunction with a lighting device.

As shown in FIG. 1, housing 20 may be cylindrical or conical in shape and may have a generally circular upper section 22, a generally conical body 24, and a generally hollow circular bottom section 26. Circular upper section 22 may have a generally circular opening 28 that may pass through its top surface 30. The sections 22, 24 and opening 28 may be generally configured with base 50 to receive a cylindrical barrel of a flashlight (not shown).

It should be noted that while cradle 10 described herein shows a generally conical or cylindrical shape with a generally circular upper section 22, a generally circular bottom section 26, a generally circular base 50, and a generally circular top opening 28, other shapes may be used to receive flashlights and other lighting devices that are not cylindrical or that do not have generally circular cross sections. Accordingly, the current invention is not limited to a conical shaped charger with a circular upper section 22, a circular lower section 26, a circular base 50 and a circular top opening 28.

As discussed in more detail below, cradle 10 may receive and support a flashlight while it is being recharged. In addition, bottom section 26 may have dimensions so that it generally corresponds to base 50 such that base 50 may generally reside within bottom section 26. The bottom portion 52 of base 50 may generally form the bottom portion of cradle 10. Preferably, housing 20 and base 50 provides enough space so that PCB 100 may also reside within cradle 10.

The manner in which housing 20, base 50 and PCB 100 may be configured together to form cradle 10 is now discussed in more detail. Base 50 may have a shape and size that generally corresponds to the shape and size of bottom portion of bottom section 26 such that base 50 may generally fit inside bottom section 26. In a preferred embodiment, bottom section 26 and base 50 may be circular in shape, and base 50 may fit within housing 20 so that their bottom surfaces are generally flush. It is also preferred that the fit between housing 20 and base 50 is snug so that there are no gaps between bottom portion 52 of base 50 and the outer edges of the generally hollow bottom section 26 to keep out dirt and other debris to protect PCB 100.

PCB 100 may reside within the cavity formed by housing 20 and base 50. As shown in FIG. 2, PCB 100 may be supported by upward guide posts 54, 56. Upward guide posts 54, 56 may extend upward from the top of bottom portion 52 of base 50 and may be positioned at a spacing that may generally correspond to the width dimension of the PCB 100. Guide posts 54, 56 may also each have an inner corner notch section 60, 62, respectively, running vertically along guide posts 54, 56. The dimension between the inner wall of notch 60 on guide post 54 and the inner wall on notch 62 on guide post 56 may generally correspond to the width dimension of PCB 100. One side of PCB 100 may be inserted into notch 60 while the opposite side of PCB 100 may be inserted into notch 62. It is preferred that PCB 100 may be held snugly within notches 60, 62 of guide posts 54, 56. While FIG. 2 depicts two guide posts 54, 56 as supporting PCB 100, other numbers of guide posts may be used, as may other types of supports for PCB 100.

Base 50 may also have a contact housing 58 that may extend upward from the top of bottom portion 52 of base 50 and may be positioned on the inner side of guide posts 54, 56. In a preferred embodiment, contact housing 58 may be generally rectangular in shape and may be positioned such that the front of contact housing 58 may face the open notches 60, 62 of guide posts 54, 56, respectively. It is also preferred that contact housing 58 be spaced apart from open notches 60, 62 by a distance that may generally correspond to the thickness of PCB 100. Accordingly, PCB 100 may be placed between notches 60, 62 as described above and the back surface of PCB 100 may be generally supported by the front of contact housing 58 as shown in FIG. 2. It may be preferred that the back of PCB 100 and the front of contact housing 58 make physical contact with each other and that the respective surfaces are flush. In this configuration, the position of PCB 100 may allow for it to be easily inserted during manufacturing, and easily removed and replaced if the need for replacement ever occurs. Additional functionality of contact housing 58 will be described in later sections.

Base 50 may also include an upward hollow section 64 that may extend upward from the top of bottom portion 52 of base 50 as shown in FIG. 2. The cross sectional shape of upward hollow section 64 may generally correspond to the shape of opening 28 that may pass through top surface 30 of housing 30. Opening 28 of housing 20 and upward hollow section 64 of base 50 may be generally configured to receive a cylindrical barrel of a flashlight (not shown). While FIG. 1 depicts this shape as being generally circular, other shapes may be used such as square, triangular, octagonal, and other shapes. In addition, while FIG. 1 depicts hollow section 64 and opening 28 as being positioned generally in the center of cradle 10, hollow section 64 and opening 28 may also be located in other positions of cradle 10.

Upward hollow section 64 may be supported by vertical support structures 66 that may extend upward from the top of bottom portion 52 of base 50. Vertical support structures 66 may be connected to the top of bottom portion 52 of base 50 and to the outer wall of hollow section 64. In this configuration, vertical support structures 66 may extend radially outward from the wall of hollow section 64 and may provide lateral support to the wall. While FIG. 1 shows seven support structures 66 supporting hollow section 64, other numbers of support structures 66 may be used. In addition, support structures 66 may be evenly spaced around the circumference of hollow section 64 or may be positioned with uneven spacings.

In a preferred embodiment, the back of contact housing 58 may be joined with a portion of the wall of hollow section 64 such that the wall of hollow section 64 may form the back of contact housing 58 as shown in FIG. 1. However, contact housing 58 may also be an independent structure and may not be joined with hollow section 64. In any event, contact housing 58 and hollow section 64 may be positioned adjacent to each other or in close proximity for reasons that will be described in later sections.

As described above with reference to housing 20 in FIG. 1, upper section 22 may have an opening 28 that may pass through its top surface 30. In addition, opening 28 may have an inner wall 29 that may extend from top surface 30 of housing 20 downward at least a portion of opening 28 that may define an inner circumference of opening 28.

In addition, in this configuration, upward hollow section 64 may extend upward within housing 20 while the inner wall 29 of opening 28 may extend downward. In a preferred embodiment, the top surface of upward hollow section 64 and the bottom surface of inner wall 29 may come into contact with each other and be generally flush when base 50 is configured within housing 20 to generally form the body of cradle 10. This may prevent dirt or other debris from entering into the inner body of cradle 10 and contaminating its inner components such as PCB 100.

It should also be noted that opening 28 need not have an inner wall 29 extending from top surface 30 of housing 20 downward at least a portion of opening 28. Instead, upward hollow section 64 of base 50 may extend through opening 28 to top surface 30 of upper section 22 when base 50 is configured with housing 20 to form cradle 10. In this embodiment, it is preferred that the top surface of upward hollow section 64 be generally flush with top surface 30 of housing 20 when cradle 10 is formed. It is also preferred that the fit between upward hollow section 64 and opening 28 be snug to avoid gaps between hollow section 64 and opening 28 to keep out dirt and other debris to protect the inner components of cradle 10 such as PCB 100.

It should also be noted that base 30 need not have an upward hollow section 64 that may extend upward from the top of bottom portion 52 of base 50. Instead, inner wall 29 of opening 28 may extend downward to the top of bottom portion 52 of base 50 when base 50 is configured with housing 20 to form cradle 10. In this embodiment, it is preferred that the bottom surface of inner wall 29 of opening 28 be generally flush with the top of bottom portion 52 of base 50 when cradle 10 is formed. It is also preferred that the fit between inner wall 29 and the top of bottom portion 52 of base 50 be snug to avoid gaps between the bottom of inner wall 29 and the top of bottom portion 52 to keep out dirt and other debris to protect the inner components of cradle 10 such as PCB 100.

To assemble housing 20, base 50 and PCB 100 together in the configuration as shown in FIG. 1 and FIG. 2, screws 68 may pass through holes 70 on base 50 and screw into receiving holes that may be located on an upper inner surface (not shown) within housing 20. The receiving holes may be threaded to engage screws 68. It should be noted that other means may be used to join housing 20 and base 50 such as clips or snaps. Once screws 68 are secured, housing 20, base 50 and PCB 100 may generally form cradle 10 as shown in FIG. 2.

In this configuration as shown in FIG. 1 and FIG. 2, housing 20, base 50 and PCB 100 may form cradle 10 that is small and compact. This allows cradle 10 to fit and be utilized in small spaces such as in a cup holder that may exist in many automobiles available in the market, on a crowded table top, or in other tight spaces. This small and compact design may also allow cradle 10 to be stored in small spaces such as in a shallow drawer. Furthermore, because of the small and compact design of cradle 10, it may be easy to bring cradle 10 on travel since it may easily fit inside a briefcase or other small travel bag.

PCB 100 is now described in more detail with respect to FIG. 3. PCB 100 may include a mode control circuit, a battery recharging circuit, a battery monitoring circuit, an LED monitoring circuit, a read only memory circuit, a read and write memory circuit, an input/output (IO) circuit, electrical charging contacts 102, 104, LED 106, and IO receptacle 108. These components will be discussed in detail below. In addition, application software may be provided with cradle 10 that may allow PCB 100 to interact with a computer or other controller. This software will also be described in detail in later sections.

The recharging circuit of PCB 100 may provide the appropriate electrical current and voltage to properly recharge the rechargeable power source while the lighting device is engaged with cradle 10. To make electrical contact with the lighting device's rechargeable power source, PCB 40 may include electrical charging contacts 102, 104 positioned on the body of the PCB. In addition and as shown in FIG. 1, contact leads 72, 74 may be placed into, properly positioned, and held securely within the contact housing 58 such that contact leads 72, 74 may make electrical contact with electrical charging contacts 102, 104 respectively when PCB 100 is secured within upward guide posts 54, 56 and held flush against the front of contact housing 58 as described above. Contact leads 72, 74 may be made of electrically conductive material such as copper or other materials.

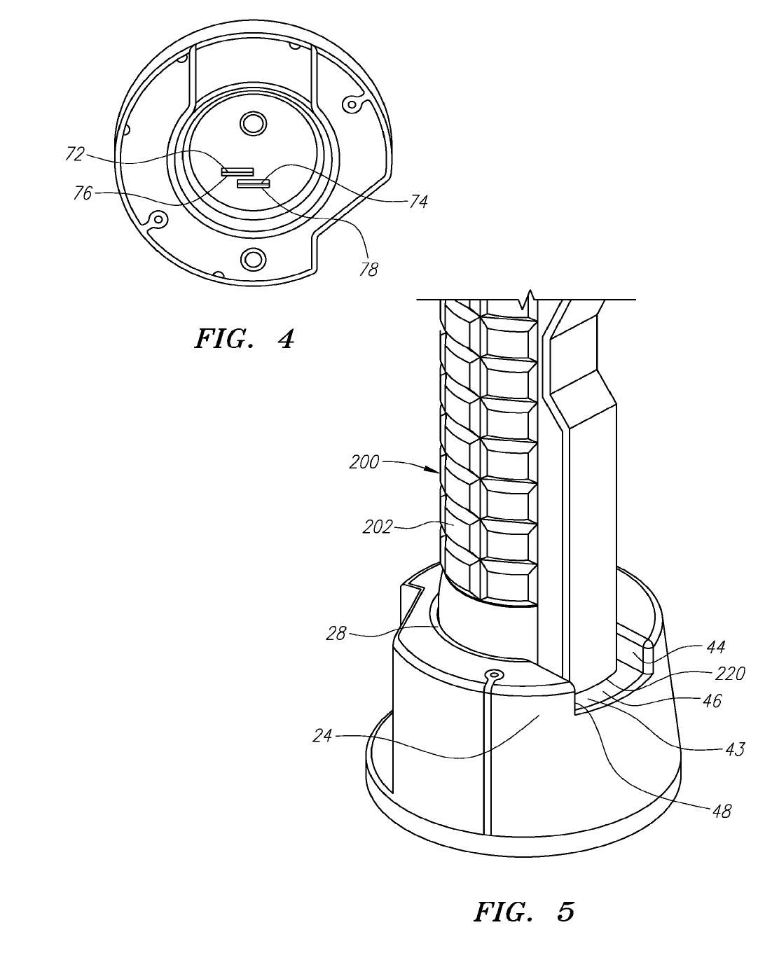

Contact leads 72, 74 may extend from charging contacts 102, 104 that may be on the back of PCB 100 through contact housing 58 and through slots 76, 78 respectively in the wall of upward hollow section 64 as shown in FIG. 4. In this configuration, contact leads 72, 74 may be configured and positioned to electrically contact a lighting device that may be placed in cradle 10. In a preferred embodiment, cradle 10 may be designed such that contact leads 72, 74 electrically contact commutating rings that may be positioned on the exterior of the barrel of a flashlight. To this end, contact leads 72, 74 may pass through slots 76, 78 and slightly protrude through the wall of upward hollow section 64 and extend into the empty space within hollow section 64 where they may contact the commutating rings of a flashlight placed in cradle 10. The contact leads 72, 74 may be spring-loaded such that constant force may be applied between the leads 72, 74 and the commutating rings to help ensure a consistent electrical contact with the flashlight. The commutating rings on the outside barrel of the flashlight may then be connected to the rechargeable power source of the flashlight in order to recharge the source.

Referring again to FIG. 3, PCB 100 may include an LED 106 that may emit a color when the flashlight's rechargeable power source is being charged by the recharging circuit on PCB 100. This color may be green or red but other colors including white light may also be utilized. The LED 106 may also emit a different color when the lighting device's rechargeable power source has been fully charged. Alternatively, LED 106 need not emit any color when charging is complete. By emitting a specific color when charging is in effect, and a different color or no color at all when the charging is complete, the recharging circuit on PCB 100 may advise the user as to the recharging status.

In the embodiment described herein, LED 106 that may be on PCB 100 may be contained within housing 20 and thus not readily visible to the user. Accordingly, cradle 10 may include light pipe 32 as shown in FIG. 1. Light pipe 32 may transmit the light from LED 106 to a position on cradle 10 that is visible to the user, such as top surface 30 of housing 20. While FIG. 1 shows this light pipe 32 positioned in hole 34 to transmit light from LED 106 on PCB 100 to top surface 30 of cradle 10, light pipe 32 may be located in other positions on cradle 10.

As shown in FIG. 1 and FIG. 3, PCB 100 may also include IO receptacle 108 that may receive a charging plug that may be attached to an electrical cable that may in turn be plugged into an electrical outlet, a USB port, a computer, a cigarette lighter or other external electrical power source (not shown). Charging plug may be connected to the recharging circuit on PCB 100 such that it may provide the necessary electrical current and voltage to the recharging circuit on PCB 100 to allow the recharging circuit to recharge the lighting device's rechargeable power source when the lighting device is secured within cradle 10.

To this end, housing 20 may include slot 36 that may allow a charging plug to pass through housing 20 and engage receptacle 108 when base 50 is configured with housing 20 to generally form the bottom of cradle 10, and with PCB 100 configured within cradle 10 as described above. Slot 36 may be positioned to coincide with the position of IO receptacle 108 on PCB 100 when PCB 100 is configured and secured within cradle 10 as described above such that a charging plug may pass through slot 36 to engage IO receptacle 108. Slot 36 may be large enough so that the charging plug may pass through housing 20 to engage receptacle 108. Slot 36 may also generally conform to the size and shape of IO receptacle 108 such that there are no gaps or spaces between receptacle 108 and the walls defining the circumference of slot 36 in order to prevent dirt or other debris from entering cradle 10.

In one embodiment, charging plug may comprise a mini-USB plug and IO receptacle may comprise a jack that may accommodate a mini-USB plug. However, other types of plugs and jacks may also be used.

In addition, and as depicted in FIG. 1 and FIG. 2, housing 20 may also include side notch 38 that may be formed by side surface 40, side surface 41 and bottom surface 42. Side notch 38 and side surface 40 may be positioned on housing 20 such that slot 36 may be positioned on side surface 40 to engage IO receptacle 108 when housing 20, base 50 and PCB 100 are configured to form cradle 10 as described above. Side notch 38 may allow the body of a charging plug (not shown) to be engaged with IO receptacle 108 to extend from side wall 40 into the interior region of side notch 38.

The size of side notch 38 may be large enough to generally accommodate the body of a charging plug engaged with receptacle 108 such that at least a portion of the body of the charging plug does not extend outside the circumference of generally conical body 24 of cradle 10 as defined by the outer and generally upright sides of housing 20. This may allow the configured cradle 10 with the charging plug engaged to be placed into a generally circular cup holder or other circular receptacle without obstruction. That is, the body of the charging plug may be generally contained within side notch 38 so that it does not significantly extend beyond the outside walls of cradle 10, thereby not obstructing cradle 10 from generally fitting into a circular cup holder. While FIG. 1 and FIG. 2 depict side notch 38 extending to top surface 30 of housing 20, side notch 38 may not necessarily extend to top surface 30. In addition, while FIG. 1 and FIG. 2 depict side notch 38 as not extending to bottom section 26 of housing 20, side notch 38 may extend to the bottom section 26. Also, while FIG. 1 and FIG. 2 depict slot 36 as being located on side surface 40, slot 36 may be located on other surfaces of side notch 38 or of cradle 10 in general. FIG. 1 and FIG. 2 also depict side notch 38 as being formed by three surfaces, however, side notch 38 may be formed by other numbers of surfaces and may be positioned in other areas on the cradle such as the top, the bottom or other areas.

Continuing on, as depicted in FIG. 1 and FIG. 2, housing 20 may include top notch 43 that may be formed by side surface 44, bottom surface 46 and side surface 48. As shown in FIG. 5, top notch 43 may accommodate side clip 220 that may be located on the side of flashlight 200 when flashlight 200 is placed into cradle 10. The width of top notch 43 may be defined by the distance between side surface 44 and side surface 48 and may be wide enough to accommodate the width of side clip 220. The depth of top notch 43 may be defined by the distance between top surface 30 of housing 20 and bottom surface 46 of top notch 43 and may be sized so that when flashlight 200 is inserted into cradle 10 with side clip 220 generally resting within top notch 43, the commutating rings (not shown) on flashlight 200 may be properly positioned within cradle 10 to make electrical contact with contact leads 72, 74. This may allow the rechargeable power supply within flashlight 200 to be recharged by cradle 10 as will be described in detail in later sections.

Top notch 43 as shown in FIG. 5 may allow conical body 24 of cradle 10 to extend upward along barrel 202 of flashlight 200 beyond the level of side clip 220 when the flashlight is positioned in cradle 10 in order to provide lateral support to flashlight 200 when configured within cradle 10. As shown, side clip 220 may be generally positioned to rest within top notch 43 and conical body 24 may extend upward along barrel 202 of flashlight 200 beyond the bottom of side clip 220. With conical body 24 extending beyond the bottom of side clip 220, inner walls 29 of generally opening 28 may also extend upward along barrel 202 of flashlight 200 and may provide additional vertical support to flashlight 200 in cradle 10.

In this manner, the height of inner walls 29 and therefore the amount of lateral support that cradle 10 may provide to flashlight 200 may not be limited by the position of side clip 220 on barrel 202 of flashlight 200. The shape of opening 28 may generally correspond to the cross-sectional shape of barrel 202 of flashlight 200 and that the diameter of opening 28 be slightly larger than the diameter of the cross-section of barrel 202 of flashlight 200 such that flashlight 200 may fit snugly within opening 28.

Top notch 43 may also serve to properly align flashlight 200 within cradle 10 such that the commutating rings (not shown) on barrel 202 of flashlight 200 may make proper electrical contact with contact leads 72, 74. That is, there may be an preferable rotational position of barrel 202 of flashlight 200 within opening 28 of cradle 10 such that commutating rings on barrel 202 of flashlight 200 may make proper electrical contact with contact leads 72, 74. Top notch 43 may be positioned such that when barrel 202 of flashlight 200 is placed into opening 28 with side clip 220 of the flashlight resting generally within top notch 43, that this rotational position of flashlight 200 within cradle 10 result in the commutating rings of flashlight 200 making adequate electrical contact with contact leads 72, 74.

In one embodiment, commutating rings on barrel 202 of flashlight 200 may not extend around the entire circumference of barrel 202 of flashlight 200, and instead may only be placed in the area of barrel 202 that may make electrical contact with contact leads 72, 74 when flashlight 200 is placed within cradle 10 with the side clip configured within top notch 43. To this end, commutating rings may not necessarily be rings but may be other shaped electrical contacts that may be properly positioned on barrel 202 of flashlight 200 to make electrical contact with contact leads 72, 74 when flashlight 200 is configured in cradle 10 as described above.

The manner in which a lighting device may be inserted into cradle 10 is now further described. In a preferred embodiment, the bottom of barrel 202 of lighting device 200 may be placed into opening 28 of housing 20 of the assembled cradle 10 with the bottom surface of bottom portion 52 of base 50 of cradle 10 resting on a support surface such as a table top or within a cup holder of an automobile such that cradle 10 may reside in a generally upright position. The diameter of opening 28 may be slightly larger than the diameter of the cross section of the bottom portion of barrel 202 of lighting device 200 such that the bottom of barrel 202 may fit inside opening 28. The diameter of opening 28 may be such that the bottom of barrel 202 fits snugly into opening 28 and that barrel 202 may be generally supported by inner walls 29 of opening 28. In addition, the diameter of opening 28 may be smaller than the diameter of the top of flashlight 200 such that the top of flashlight 200 may not fit inside opening 28. This may prevent flashlight 200 from being inserted into cradle 10 upside down.

With cradle 10 in a generally upright position, the force of gravity on flashlight 200 may tend to pull the bottom of barrel 202 of flashlight 200 into cradle 10 as shown in FIG. 5. The rotational position of barrel 202 of flashlight 200 may be such that side clip 220 on barrel 202 may be positioned to rest generally in top notch 43. In this position, it may be preferable that the commutating rings or other electrical contacts (not shown) on barrel 202 of flashlight 200 make adequate electrical contact with contact leads 72, 74 (shown in FIG. 4) within cradle 10 in order to recharge the power source of flashlight 200. To this end, in a preferred embodiment, contact leads 72, 74 may pass through slots 76, 78 and protrude through the wall of upward hollow section 64 and extend into the empty space within hollow section 64 where they may contact the commutating rings or other electrical contacts of a flashlight placed in cradle 10.

The contact leads 72, 74 may be spring-loaded such that constant force may be applied between leads 72, 74 and the commutating rings or other electrical contacts on flashlight 200 to help ensure adequate and consistent electrical contact with the flashlight. The commutating rings or other electrical contacts on outside barrel 202 of flashlight 200 may then be connected to the rechargeable power source of flashlight 200 in order to recharge the source.

To remove lighting device 200 from cradle 10, the procedure described above may be followed in reverse order. That is, barrel 202 of flashlight 200 may be lifted upward and out of opening 28 of housing 20 of the assembled cradle 10.

The functionality of PCB 100 and the application software that may be provided with cradle 10 will now be described in further detail. As mentioned earlier, PCB 100 may include a mode control circuit, a battery recharging circuit, a battery monitoring circuit, an LED monitoring circuit, a read only memory circuit, a read and write memory circuit, an input/output (IO) circuit, electrical charging contacts 102, 104, an LED 106, and an IO receptacle 108. In addition, application software may be provided with cradle 10 that may allow PCB 100 to interact with a computer or other controller.

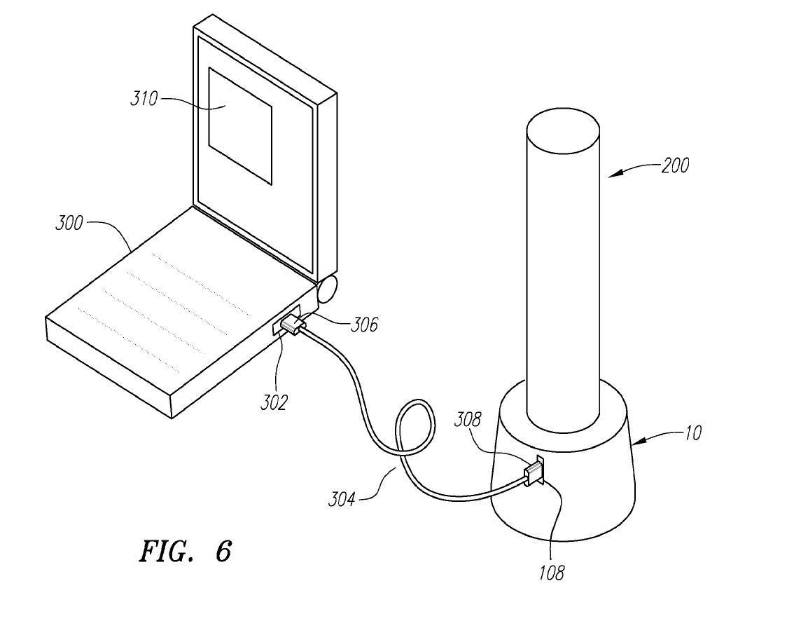

As shown in FIG. 6, flashlight 200 may engage cradle 10, and cradle 10 may be electrically connected to computer 300 by electrical cable 304. Cable 304 may include plug 308 that may engage IO receptacle 108 on PCB 100 within cradle 10. Cable 304 may also include plug 306 that may engage computer receptacle 302. The electrical connection between cradle 10 and computer 300 allows communication between computer 300 and PCB 100. A user of computer 300 may interact with PCB 100 by using application software that may reside on computer 300. Also, computer 300 may provide electrical current and voltage to the recharging circuit of PCB 100 via electrical cable 304. Cradle 10 may provide the necessary electrical current and voltage to recharge the power source in flashlight 200. While the description above depicts cradle 10 engaged with a computer 300, cradle 10 may be engaged with other types of controllers as well.

Plug 308 may comprise a mini-USB plug and IO receptacle may comprise a corresponding jack. Alternatively, plug 306 may comprise a standard USB plug and a corresponding jack may be used. Other types of plugs and jacks may also be used.

Application software that may be provided with cradle 10 may be loaded onto computer 300. Application software may be provided to the user on a memory disc, through an Internet download, or through other means. In addition, application software may be factory loaded onto the read only memory circuit or the read-write memory circuit within PCB 100 such that when cradle 10 engages the computer, the application software may be transferred thereto. It should be noted that application software may include software code, information stored in databases or other means, webpage files, audio files, video files, animation files, text files, other media type files, templates, documents, or other types of materials and files that may be utilized to perform its functionality as described in later sections.

Once installed and run on computer 300, application software may include a user interface 310 that may appear on the screen or other visual interface of computer 300 as shown in FIG. 6. User interface 310 may allow a user to interact with the application software as described below.

In one embodiment, software application may recognize when cradle 10 is plugged into or otherwise engaged with computer 300. When this happens, software application may notify the user via user interface 310 that cradle 10 is plugged into computer 300. The software application may also recognize whether or not a flashlight 200 is engaged with cradle 10 and may relay this information to the user.

If no flashlight 200 is properly engaged with cradle 10, the software application may alert the user so that the user may reposition or insert flashlight 200. The application software may also lend assistance to the user to help the user rectify the problem and to properly adjust flashlight 200 within cradle 10. This assistance may be in the form of a software wizard or other type of assistance and may include textual instructions, illustrative instructions, audio instructions, any other types of instructions or any combination of different types of instructions. In addition, the assistance may be displayed through user interface 310, through the computer screen, through computer speakers or through other interfaces to the user. If flashlight 200 is properly engaged with cradle 10, the application software may notify the user so that the user may proceed.

In another embodiment, information may be factory loaded onto the read only memory circuit of PCB 100 and this information may be accessible by the software application to be relayed to the user via user interface 310 or other means. For example, the factory may load 1) the model number of flashlight 200 and cradle 10, 2) the serial number, 3) the date of manufacture, 4) the place of manufacture, and other information regarding flashlight 200 and cradle 10 onto the read only memory circuit of PCB 100 within cradle 10. When cradle 10 and flashlight 200 are properly engaged together and with computer 300, the user may be able to access this information through user interface 310 or other means. While it may be preferable for this factory loaded information to be loaded onto the read only memory circuit of PCB 100 such that it may not be edited or otherwise altered, the information may be loaded onto the read-write memory circuit as well.

Other types of information may also be factory loaded onto the memory circuits within PCB 100 such as 1) instructions on how to properly use flashlight 200 and cradle 10, 2) warranty information regarding the products, 3) maintenance information, 4) replaceable parts information such as the type of bulb or LED that the flashlight may be replaced, 5) how to order replaceable parts, 6) how to properly install replaceable parts, 7) troubleshooting instructions to help repair or fix problems that may arise with flashlight 200 or cradle 10, 8) promotional information regarding accessories that may be available for flashlight 200 and cradle 10, 9) promotional information on other related products, 10) history of flashlight usage and charging, or any other types of information.

This information may be accessible by the software application when the cradle 10 is engaged with computer 300. While cable 304 has been described above, cradle 10 may engage computer 300, wirelessly or by other means. In one embodiment, flashlight 200 need not be in cradle 10 for the information to be provided.

The application software may automatically access some or all of this information and may provide it to the user. Alternatively, the software application may allow the user to choose the specific information he or she wishes to access. In addition, while this description depicts the above described information as being stored on the read only or read-write memory circuits within PCB 100 of cradle 10, some or all of this information may also be stored in data files within the software application itself such that the information may also be stored on computer 300 or other controller by the application software as desired.

In another embodiment, the application software may allow the user to load information onto the read-write memory circuit of PCB 100 within cradle 10 to be stored on read-write memory circuit for future reference. This may be accomplished through use of user interface 310 on computer 300 when cradle 10 is engaged with computer 300. For instance, user interface 310 may have data entry fields that may allow the user to enter various information into the software application. Once the information is entered, the software application may have a means for the user to load the information onto the memory circuit of PCB 100, such as a clickable button on user interface 310, a hard key on the computer keyboard, or other means.

Examples of the types of information that may be entered into the software application via user interface 310 to be loaded onto the read-write memory circuit may include 1) the flashlight owner's name, 2) the flashlight owner's contact information such as phone number, mailing address and email address, 3) date and place of purchase of the products, 4) a personal message to another user of flashlight 200 in the case that flashlight 200 may be a gift, and other information. This information may preferably be loaded onto PCB 100 when flashlight 200 may be engaged with cradle 10 or not.

In another embodiment, PCB 100 may interact with and monitor the status of flashlight 200 and may relay this information to the user via the application software when flashlight 200 is engaged with cradle 10 and cradle 10 is engaged with computer 300.

For example, PCB 100 may interact with the rechargeable power source within flashlight 200 and may monitor the power source's status and relay this information to the user. With flashlight 200 electrically engaged with cradle 10, the battery monitoring circuit within PCB 100 may also be electrically connected to rechargeable battery via electrical charging contacts 102, 104 and contact leads 72, 74, and may monitor the battery life information of the battery. For instance, the battery monitoring circuit may determine how much power is remaining in the rechargeable battery and subsequently how long the flashlight may remain powered on before the battery may run out of power. The battery monitoring circuit may also determine how much of the battery's power has already been used and how long the flashlight has been in use. In addition, the battery monitoring circuit may determine how long it may take to recharge the rechargeable battery to its full power capacity. Also, the battery monitoring circuit may determine how long the flashlight may remain powered on once the rechargeable power source has been recharged to its full power capacity.

Because a rechargeable power source's ability to retain a charge may degrade with usage over time, it may also be preferable that the battery monitoring circuit monitor the battery's ability to receive a charge and the maximum power that the battery is able to retain upon full charge. The battery monitoring circuit may also determine the rate of the battery discharge as it powers the flashlight 200. At some point, the battery may degrade to a point that it may not be able to hold an adequate charge for an adequate period of time. The battery monitoring circuit may also provide this information to the user. The application software may include threshold settings that may be set by the factory or by the user regarding the criteria for the battery to be replaced such as the expected amount of time that the battery may be able to power on the flashlight before it may run out of power.

In yet another embodiment, PCB 100 may include an LED monitoring circuit that may monitor the status of the flashlight's LED. As with rechargeable batteries, LEDs may also degrade with usage over time and may occasionally require replacement. LED monitoring circuit within PCB 100 may monitor the power consumption and resulting output of the flashlight's LED as well as its various electrical parameters such as its resistance, its capacitance and its inductance to determine its current operating status and life expectancy. This information may be provided to the user and the application software such that the user or the application software may make a judgment regarding the need to replace the LED. The application software may include threshold settings that may be set by the factory or by the user regarding the criteria for the LED to be replaced such as the life expectancy of the LED and the optical output brightness that the user may expect.

It should be noted that PCB 100 may also include other monitoring circuits that may monitor other components within flashlight 200 as well as other characteristics and other aspects of flashlight 200.

PCB 100 may also include a mode control circuit that may control, set or otherwise change the operational modes that are available on flashlight 200. For example flashlight 200 may include a control circuit that may control or otherwise adjust flashlight 200 to operate in different operational modes such as default constant beam flashlight mode, two mode quick click adjustable mode, three mode quick click adjustable mode, law enforcement tactical mode, military tactical mode, blinking mode, SOS mode, easy click Morse code mode, night light mode, compass mode, and other modes.

To change the available modes, user interface 310 may include a drop-down menu listing the available modes to choose from, a check box, a radio button, a text input field, or other means, within user interface 310 that the user can manipulate to choose the flashlight operational mode they wish to set. Mode control circuit within PCB 100 may then interact with the control circuit within flashlight 200 to set the available modes. The application software may inform the user whether the available modes were successfully set or not.

In view of the foregoing, the charging cradle 10 of the current invention provides at least the following advantages over prior charger cradle designs.

First, the small, compact and preferably circular cross section of charging cradle 10 allows it to fit and be utilized in small spaces such as in a cup holder that may exist in many automobiles available on the market. The compact design also makes it easy to store cradle 10, such as in a suitcase when traveling.

Second, the components of cradle 10 preferably fit together to avoid components sticking out from the profile of housing 20 and base 50. This avoids components protruding from the cradle that might easily be broken off. This also allows for the easy assembly and replacement of parts as necessary. This increases durability, eases manufacturing and lowers cost.

Third, the shape of cradle 10 makes it intuitively easy to insert flashlight 200 into cradle 10 in the proper position, and avoids inserting it in the reverse position.

Fourth, information may be stored within the memory circuits of PCB 100 within cradle 10, or within the application software that may be provided to the user with cradle 10. This information may include information stored by the factory such as product operational instructions, warranty information, model and serial number information or other information. This information may also include information stored to PCB 100 by the user through use of the application software such as user's name and contact information. As such, cradle 10 may be a “smart” cradle.

Fifth, PCB 100 may monitor various components and aspects of flashlight 200 such as the battery charge status and the LED operational status, and may provide this information to the user via the application software. This is another aspect of the “smart” cradle.

Sixth, the user may control and set the available modes of the flashlight via the application software without having to manipulate the flashlight's manual controls.

The present invention includes a number of aspects and features which may be practiced alone or in various combinations or sub-combinations, as desired. While preferred embodiments of the present invention have been disclosed and described herein for purposes of illustration and not for purposes of limitation, it will be understood by those skilled in the art that various changes in form and detail may be made therein without departing from the spirit and scope of the invention.

What is claimed is:

1. A process for allowing a user to electronically interact with a flashlight via a computer, comprising the steps of:
inserting the flashlight into a smart cradle which receives the flashlight and is configured with a printed circuit board (“PCB”) that can communicate electronically with both the flashlight and the computer; and
using the computer to interact with an application software program via the PCB;
wherein the application software program is operable when the flashlight has engaged the smart cradle.

2. The process of claim 1 wherein the application software program allows the user to access a mode control circuit for changing a plurality of operational modes available on the flashlight.

3. The process of claim 2 wherein the user can change a default set of operational modes available on the flashlight.

4. The process of claim 2 wherein the user can control a set of available operational modes of the flashlight without having to manipulate a manual control of the flashlight for changing the set of available operational modes of the flashlight.

5. (original The process of claim 1 wherein the application software program allows the user to monitor battery life of a battery the flashlight.

6. The process of claim 1 wherein the application software program allows the user to access one or more data files relating to the flashlight.

7. The process of claim 1 wherein the application software program allows the user to load information into a memory medium of the PCB.

8. The process of claim 1 wherein the smart cradle communicates electronically with the flashlight through use of a charging circuit of the flashlight.

9. The process of claim 8 comprising the further step of charging a rechargeable battery of the flashlight through use of the cradle.
